(19) United States
(12) Patent Application Publication
(10) Pub. No.: US 2016/0309955 A1
(43) Pub. Date: Oct. 27, 2016

(54) BAKEWARE

(71) Applicant: ISHIZUKA GLASS CO., LTD., Iwakura-Shi (JP)

(72) Inventor: Aya FUNAYAMA, Iwakura-Shi (JP)

(21) Appl. No.: 14/694,126

(22) Filed: Apr. 23, 2015

(51) Int. Cl. A47J 37/01; A47J 36/02; A47J 36/04

(52) U.S. Cl. CPC A47J 37/01; A47J 36/04; A47J 36/027

(57) ABSTRACT

The present invention relates to glass bakeware which has excellent non-sticking property and is hard to burn foods and allows for easy removal of soils. The bakeware of the present invention is used to heat and cook foods by use of a microwave oven, and is configured so that a transparent ceramic coating layer 2 which prevents burning of foods is formed on the inner surface of a transparent glass container 1. The ceramic coating layer 2 preferably contains ceramic particles and mica particles, and can further contain an antimicrobial metal.

### FIELD OF THE INVENTION

The present invention relates to bakeware made of glass for use in heating and cooking of various kinds of foods such as gratin, pizza, cheese cake, custard pudding and quiche by use of a cooking appliance such as a microwave oven.

### BACKGROUND OF THE INVENTION

Conventionally, dishes and bowls made of ceramic have been mainly used as bakeware for use in heating and cooking of foods. However, ceramic is opaque, and thus involves the disadvantage that the contents in ceramic bakeware cannot be seen. Therefore, transparent glass bakeware has also been proposed recently.

Borosilicate glass having excellent heat resistance and thermal shock resistance is used as a material for glass bakeware. Such glass bakeware advantageously has a transparent and beautiful appearance, cleanliness and easiness to see the contents thereof,

However, glass bakeware lacks non-sticking property, and thus has the disadvantages that foods easily burn, and that the burned foods are hard to be peeled. Further, there was the disadvantage that soils cannot be easily removed from glass bakeware. These disadvantages are unignorable to users, and have prevented the spread of glass bakeware.

JP 2010-202437 A discloses an antimicrobial heat-resistant glass container usable in a microwave oven, of which the inner surface has silver ions diffused therein. However, this aims at attaining antimicrobial property, and is not a technique of improving the non-sticking property of glass bakeware. There cannot be found any prior art document which discloses a means for effectively solving such disadvantages of glass bakeware.

### RELATED ART DOCUMENT

### Patent Document

Patent Document 1: JP 2010-202437 A

### SUMMARY OF THE INVENTION

### Problems to be Solved by the Invention

An object of the present invention is to provide glass bakeware which solves the above-described conventional problems, and which has excellent non-sticking property, is hard to burn foods and allows for easy removal of soils.

### Means for Solving the Problems

In order to solve the above-described problems, a ceramic coating layer which prevents burning of a food is formed on an inner surface of a transparent glass container, in the present invention. The phrase “ceramic coating layer” used herein means a coating layer containing metal oxide particles (ceramic particles) of silica, alumina, magnesia, zirconia or the like.

In a preferred embodiment, the ceramic coating layer contains ceramic particles dispersed in a matrix. Also, the ceramic particles are silica particles. The ceramic coating layer can further contain mica particles. Further, the ceramic coating layer is a transparent layer including heat-resistant silicone as the matrix.

### Advantageous Effect of the Invention

The bakeware of the present invention is made of glass, but, nevertheless, can prevent burning of foods also when heated in a microwave oven or the like, because its ceramic coating layer has non-sticking property. The bakeware is made of glass that is hard to be soiled and transparent, and thus can be used as dishware as it is, and can impart cleanliness and freshness to tables. The ceramic coating layer, when containing mica particles, can provide a sparkling appearance which is peculiar to mica.

### BRIEF DESCRIPTION OF THE DRAWINGS

FIG. 1 is a sectional view showing bakeware according to an embodiment of the present invention;

FIG. 2 is a sectional view showing a modified example of the bakeware shown in FIG. 1; and

FIG. 3 is a schematic enlarged sectional view showing a ceramic coating layer.

### DETAILED DESCRIPTION OF THE INVENTION

Hereinafter, preferred embodiments of the present invention will be described with reference to the drawings.

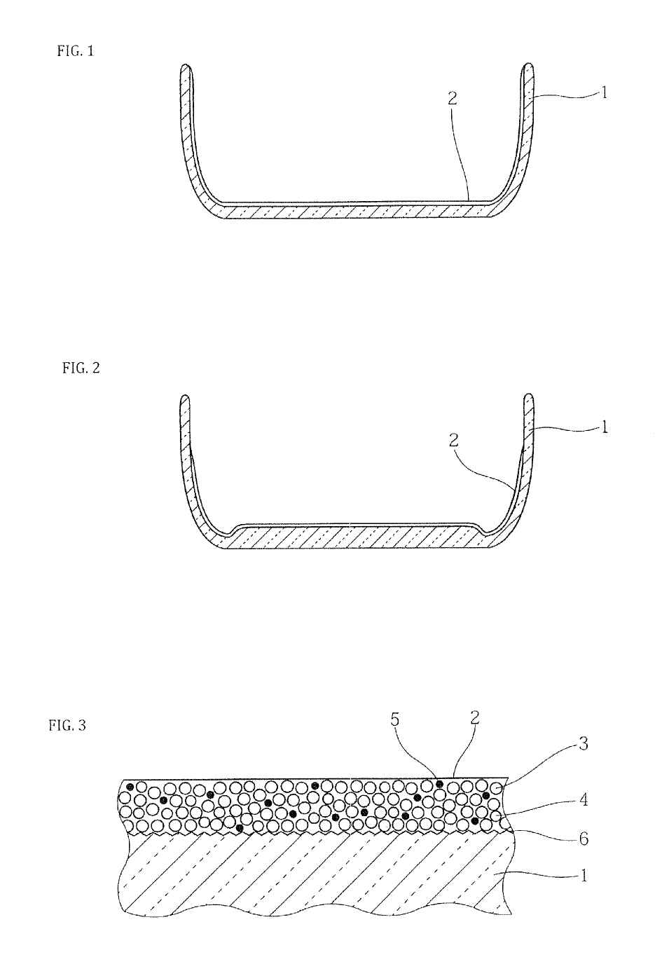

FIG. 1 is a sectional view showing bakeware according to an embodiment of the present invention, in which 1 denotes a glass container, and 2 denotes a ceramic coating layer formed on the inner surface thereof. The glass container 1 is transparent, and the usable materials for the glass container 1 can be soda lime glass instead of conventional borosilicate glass. Soda lime glass causes no problem with heat resistance so long as an ordinary bakeware using method is employed. However, borosilicate glass is superior in terms of strength against quenching, and can withstand a temperature difference of 120° C. On the other hand, non-strengthened soda lime glass is likely to be broken when being exposed to a temperature difference exceeding 35° C., and thus it is not preferable to throw tap water thereon in a heated state. The glass container 1 may have any form and size, and can take a dish-like shape, a bowl-like shape, a baking container-like shape, and the like.

The ceramic coating layer 2 is preferably formed on the entire inner surface of the glass container 1 as shown in FIG. 1, but it is also possible not to form the layer 2 in the upper portion having no possibility of being in contact with a food as shown in FIG. 2. The thickness of the ceramic coating layer 2 ranges from 3 μm to 100 μm, preferably 5 μm to 30 μm. In the meantime, in order to enhance the adhesion strength of the ceramic coating layer 2 to the glass container 1, the inner surface of the glass container 1 is preferably sand-blasted to form a fine uneven layer 6, as shown in FIG. 3. The particle diameter of the blast particles used preferably ranges from #80 to #120 (corresponding average particle diameter: 90 μm to 180 μm).

As shown in FIG. 3, the ceramic coating layer 2 is configured so that ceramic particles 3 are dispersed in a matrix. In this embodiment, the ceramic particles 3 are silica particles (hydrophobic silicon dioxide), but various ceramic particles 3 such as alumina particles, titania particles, and zirconia particles can also be used singly or mixed for use. The particle diameter is not particularly limited, but is desirably 10 μm or less for uniform dispersion throughout the layer.

The matrix of the ceramic coating layer 2 is silicone in this embodiment. This can be formed by curing polymethylsiloxane. Silicone has heat resistance, and can withstand use temperatures around 300° C. However, the component of the matrix of the ceramic coating layer 2 is not necessarily limited to silicone, and other materials may also be used so long as the materials are heat resistant and have the function of reliably holding the ceramic particle 3.

In addition to the ceramic particles 3, mica particles 4 can be dispersed in the ceramic coating layer 2. The mica particles 4 shed luster, as is used in metallic coating materials, can impart a sparkling appearance to the ceramic coating layer 2, and can improve the design of the entire bakeware.

Additionally, an antimicrobial metal 5 can also be incorporated into the ceramic coating layer 2. Silver is preferably used from the viewpoint of safety and antimicrobial property, but zinc can also be used. The antimicrobial metal 5 may be incorporated in the form of particles, but can also be carried on the ceramic particles 3 or mica particles 4.

In order to form the ceramic coating layer 2 on the inner surface of the glass container 1, ceramic particles 3 and the like are firstly dispersed in water and an organic solvent. The mixing ratio is preferably as follows: 10% to 35% (by mass) of ceramic particles 3 (for example, silica particles), 1% to 10% of mica particles on which an antimicrobial metal 5 is carried, 2% to 25% of an organic solvent (for example, isopropyl alcohol), and 30% to 45% of water. There can be employed a method comprising mixing this with polymethylsiloxane, spraying the solution mixture over the inner surface of the glass container 1 having an uneven layer 6 formed by sand blasting in advance, and then heating and drying it at 200° C. to 230° C. As a result, a ceramic coating layer 2 comprising ceramic particles 3 as the main component is formed based on principles similar to those of the sol-gel method. The ceramic coating layer 2 can also be formed by an immersion (dipping) method in addition to the above-described spraying method.

The thus-configured bakeware according to the present invention is used to heat and cook various kinds of foods such as gratin, pizza, cheese cake, custard pudding and quiche by use of a cooking appliance such as a microwave oven, and has resistance to heat around 300° C., and thus is not likely to be destroyed unless a sudden thermal impact is applied. Also, the ceramic coating layer 2 is a semitransparent layer, and especially improves its aesthetic appearance when mica particles 4 are added thereto. The ceramic coating layer 2 contains a large amount of ceramic particles 3, and thus is excellent in non-sticking property, and is hard to burn foods during heating and cooking and allows for easy removal of soils, as will be illustrated in an Example.

When the bakeware according to the present invention is heated to a high temperature above 300° C. due to some cause, silicone or the like which constitutes the matrix of the ceramic coating layer 2 is likely to be decomposed. In that case, however, the ceramic particles 3 of silica or the like, which are the main component of the ceramic coating layer 2, form a network on the surface of the glass container 1, and thus can maintain non-sticking property.

### EXAMPLE

30% (by mass) of silica particles, 20% of isopropyl alcohol, 43% of water and 7% of mica particles on which silver was carried were uniformly mixed, and the mixture was further mixed with an equal amount of polymethylsiloxane to yield a solution mixture. This solution mixture was sprayed over the inner surface of a glass container made of borosilicate glass by means of a spray nozzle, and heated and dried at 230° C. In meantime, the inner surface of the glass container was sand-blasted in advance. As a result, bakeware having a transparent or semitransparent ceramic coating layer 2 formed on the inner surface of the transparent glass container was obtained.

Eight monitors were requested to use this bakeware for cooking, and evaluated its non-sticking property, easiness of soil removal and mold releasability of foods. The results are shown in Table 1.

TABLE 1

| | | | Easiness of soil | Mold releasability of |
|---|---|---|---|---|
| | Details of cooking | Non-sticking | removal | foods |
| 1 | Herb-crusted grilled | Good | — | Good |
| | chicken | Food is not burned at | (No evaluation | Food is easy to serve. |
| | | all. | comments) | |
| 2 | Marble cake | Good | Good | Good |
| | Custard pudding | Food is not burned at | Oil is easily removed. | Cake can be easily |
| | | all. | | taken out. |
| | | | | Pudding was easily |
| | | | | peeled from dish. |
| 3 | Mini raisin cocoa | Good | Good | Good |
| | bread | As for quiche, no stuck | Soils were easily | Breads are very easily |
| | Skinless quiche | egg or burned cheese is | removed. | taken out from mold. |
| | | left. | | |
| 4 | Gratin | Good | Good | — |
| | | Food is not stuck. | Food residues could be | (No evaluation |
| | | | eliminated only by | comments) |
| | | | washing with hot | |
| | | | water. | |
| 5 | Gateaux chocolat | — | Good | Fair |
| | Banana pie | (No evaluation | Soils such as burnt | Foods are easily taken |
| | | comments) | deposits are also easily | out from mold without |
| | | | removed. | coating. |
| | | | | Banana pie was easily |
| | | | | peeled also after |
| | | | | cooled. |
| 6 | Shrimp and scallop | Good | Good | — |
| | gratin | Food is not burned | Soils are immediately | (No evaluation |
| | | even without spreading | removed by lightly | comments) |
| | | oil. | washing with sponge. | |
| 7 | Vegetable gratin | Good | Good | Good |
| | | Burn mark is not | Oil stains are not | Food is not stuck and |
| | | formed so much. | prominent, and | easy to serve. |
| | | | washing is easily | |
| | | | performed. | |
| 8 | Pizza | — | — | Good |
| | | (No evaluation | (No evaluation | Food can be easily |
| | | comments) | comments) | transferred to dish. |

Also, this bakeware (inventive product) and conventional bakeware having no ceramic coating layer (blank) were evaluated in terms of antimicrobial property in conformity to JTS Z 2801 2010. The target bacteria are E. coli and Staphylococcus aureus. The results are shown in Table 2. The antimicrobial activity value is defined by the following formula, and the above-described JTS stipulates that a substance having an antimicrobial activity value of 2.0 or more has an antimicrobial effect.

Antimicrobial activity value=log [(viable cell count after 24-hour culture of blank)/(viable cell count after 24-hour culture of inventive product)]

TABLE 2

| | | | Staphylococ- |
|---|---|---|---|
| | E. coli | | cus aureus |
| Viable cell count of | 2.4 × 10⁶ | Viable cell count of | 1.8 × 10⁴ |
| blank | | blank | |
| Viable cell count of | 6.3 or | Viable cell count of | 6.3 or |
| inventive product | less | inventive product | less |
| Antimicrobial activity | 5.5 or | Antimicrobial activity | 3.4 or |
| value | more | value | more |
| Evaluation of | Good | Evaluation of | Good |
| antimicrobial property | | antimicrobial property | |

From the data on this Example, it could be confirmed that the bakeware of the present invention is superior to the conventional one in the respective items: non-sticking property, easiness of soil removal, mold releasability of foods and antimicrobial property.

### Explanation of Reference Numerals

1. Glass container
2. Ceramic coating layer
3. Ceramic particles
4. Mica particles
5, Antimicrobial metal
6. Uneven layer

What is claimed is:

1. Bakeware comprising a ceramic coating layer formed on an inner surface of a transparent glass container, the ceramic coating layer preventing a food from burning.

2. The bakeware according to claim 1 wherein the ceramic coating layer contains ceramic particles dispersed in a matrix.

3. The bakeware according to claim 2 wherein the ceramic particles are silica particles.

4. The bakeware according to claim 3 wherein the ceramic coating layer further contains mica particles.

5. The bakeware according to claim 1 wherein the ceramic coating layer is a transparent or semitransparent layer comprising heat-resistant silicone as the matrix.
